(19) United States
(12) Patent Application Publication
(10) Pub. No.: US 2024/0017755 A1
(43) Pub. Date: Jan. 18, 2024

(54) COLLAPSIBLE SHOPPING CART

(71) Applicant: Angela Davydov-Babaev, Fresh Meadows, NY (US)

(72) Inventor: Angela Davydov-Babaev, Fresh Meadows, NY (US)

(21) Appl. No.: 18/210,610

(22) Filed: Jun. 15, 2023

Related U.S. Application Data
(60) Provisional application No. 63/390,016, filed on Jul. 18, 2022.

(51) Int. Cl. B62B 3/02; B62B 3/14; B62B 3/00; B62B 5/06

(52) U.S. Cl. CPC B62B 3/027; B62B 3/14; B62B 3/022; B62B 3/002; B62B 5/067; B62B 2501/065

(57) ABSTRACT

A collapsible shopping cart including a collapsible wheeled chassis and a cargo basket mounted thereto. The chassis has a pair of right and left side front and rear beams pivotably attached to a cargo basket floor panel and provided with rolling wheels, the entire assembly being collapsible under the shopping cart. The shopping cart/basket being formed of four collapsible panels and including a handle that can be collapsed unto the four collapsed panels of the shopping basket.

### CROSS-REFERENCE TO RELATED APPLICATION

The present non-provisional patent application claims the benefit of and priority to U.S. Provisional Patent Application No. 63/390,016, filed Jul. 18, 2022, by Angela Davydov-Babaev, and entitled “COLLAPSIBLE SHOPPING CART,” the entire contents of which are incorporated herein by reference.

### BACKGROUND OF THE INVENTION

In general, the present invention relates to carts including shopping carts and, more specifically, to collapsible shopping carts that are easier to stow in cramped spaces and carry when not being used.

In substantial part, this invention improves on the present inventor's cart described in U.S. Pat. No. 10,112,634, the contents of which are incorporated by reference herein. Indeed, the first embodiment described herein and the FIGS. 1-4 are from the aforementioned patent.

Various types of shopping carts are known in the prior art. Retailers often provide shopping carts, such as a shopping cart with an upper basket rigidly connected to a wheeled lower frame, for use by their customers on the premises to place items for purchase in the shopping car and then to carry the purchased items after checkout to the shopper's vehicle. However, in some instances, retailers do not permit the shopping cart to be removed from the store to the parking lot thus requiring the shopper to hand-carry shopping bags to the vehicle and, in other instances, shoppers are required purchase shopping bags to carry items to the vehicle for transport. What is needed is a collapsible shopping cart in which to place purchased items when both in the store and during transport in the vehicle eliminating the need to employ shopping bags at all or, if shopping bags are used, to carry the shopping bags from the store to the vehicle and directly to the ultimate storage location, such as a home pantry, without ever having to unpack the purchased items during transport from the store to the storage location.

### FIELD OF THE INVENTION

The present invention relates to the field of carts, and more particularly, to a collapsible shopping cart.

### SUMMARY OF THE INVENTION

The general purpose of the present collapsible shopping cart, described subsequently in greater detail, is to provide a collapsible shopping cart which has many novel features that result in a collapsible shopping cart which is not anticipated, rendered obvious, suggested, or even implied by prior art, either alone or in combination thereof.

To accomplish this, the present collapsible shopping cart includes a chassis. having a front axle and a rear axle, each of which has a pair of front wheels and a pair of rear wheels, respectively, distally disposed thereon. Each of a telescopic right side front beam and a left side front beam extends rearwardly from the front axle and has an outer end with a handle disposed thereon. Each of a telescopic right side rear beam and a left side rear beam extends forwardly from the rear axle. A cargo basket is mounted on the chassis and is configured to store one or more items therein. The cargo basket has a substantially rectangular floor panel that is surrounded by a pair of substantially rectangular longitudinal side wall panels, a transverse rear panel hingedly attached at a bottom edge thereof to the floor panel, and a transverse front wall panel. Each of the longitudinal side wall panels has an extension portion extending from the floor panel rearwardly beyond the rear panel. Each of the right side rear beam and the left side rear beam extends from the rear axle to a respective one of a pair of first pivot pins on the respective right side and left side of the floor panel proximal the front wall panel.

Each of a pair of front support beams, provided to ensure structural integrity of the cargo basket in a balanced level position, has a lower end pivotably disposed on the respective right side front beam and the left side front beam in a position proximal the front axle and an upper end pivotably disposed on a respective right side and left side of the floor panel in a position proximal the front wall panel. A crossbeam connects the right and left side rear beams together in a position proximal the respective one of the pair of first pivot pins to bolster the structural integrity of the cargo basket as well as the entire structure of the shopping cart. Each of pair of extension members of the floor panel is disposed on the extension portion of each of the longitudinal side wall panels and has an outward bend extending rearwardly therefrom and a distal end. Each of the right side front beam and the left side front beam extends from the front axle to a position proximal the rear end of the extension portion of the respective one of the longitudinal side wall panels. A pair of maneuvering wheels, one of which is disposed on the distal end of each extension member, is provided to assist a shopper in maneuvering the chassis and the cargo basket within a vehicle by allowing the shopper to use the handles to push the shopping cart into the cargo area of the vehicle.

Thus has been broadly outlined the more important features of the present collapsible shopping cart so that the detailed description thereof that follows may be better understood and in order that the present contribution to the art may be better appreciated.

In accordance with the second embodiment of the invention described below, the instant disclosure includes a collapsible shopping cart, comprising: a cargo basket supported on a chassis; a collapsible wheeling structure including wheels that support the chassis above ground and allow rolling the cargo basket on the ground; a handle coupled to the chassis for a user to grasp and control movement of the shopping cart; wherein the cargo basket comprises at least four panels each of which is hingedly mounted to the chassis, in a manner so that the four panels are enabled to be folded down and over each other to selectively reduce a height dimension of the cargo basket for storage purposes. In an embodiment, the handle is collapsible unto the collapsed panels.

Optionally, the handle is hingedly affixed to the shopping cart in a manner effective to enable the handle to be folded unto the four panels after said four panels have been folded unto each other. Optionally, the collapsible shopping cart includes at least one front wheel that is attached to the chassis and is so configured as to enable rolling the shopping cart unto an elevated platform. Optionally, the at least one front wheel is movable relative to the chassis between an extended position located forward of the chassis and a stored, non-extended position. Optionally, the at least one front wheel is so configured as to be forced to become folded back under the chassis as the shopping basket is pushed unto the elevated platform.

### BRIEF DESCRIPTION OF THE DRAWINGS FIGURES

FIG. 1 is an isometric view.

FIG. 2 is a side elevation view in an expanded condition.

FIG. 3 is a top view.

FIG. 4 is a side elevation view in a collapsed condition.

FIGS. 5A through 5I show various stages of a further developed version of the holding cart and its handle, being folded unto each other.

### DETAILED DESCRIPTION OF THE DRAWINGS

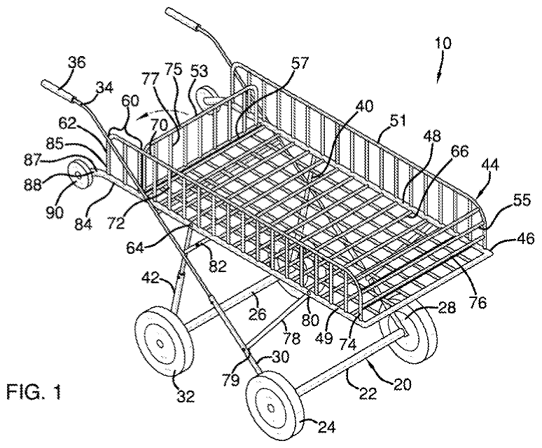

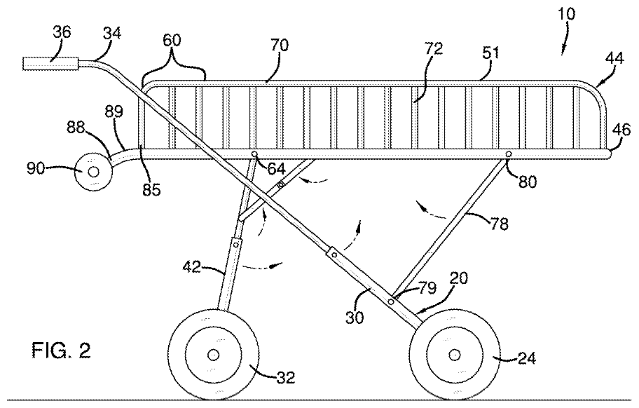

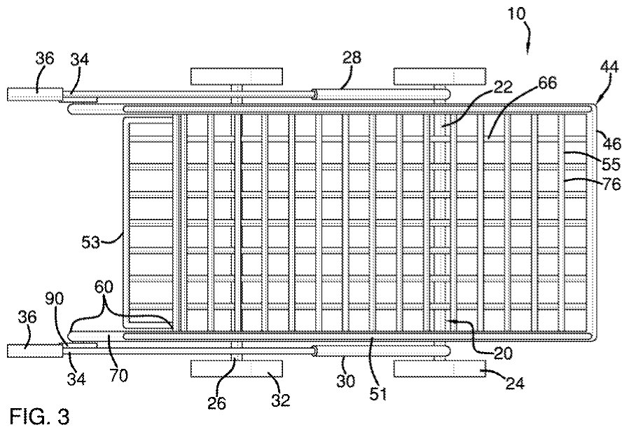

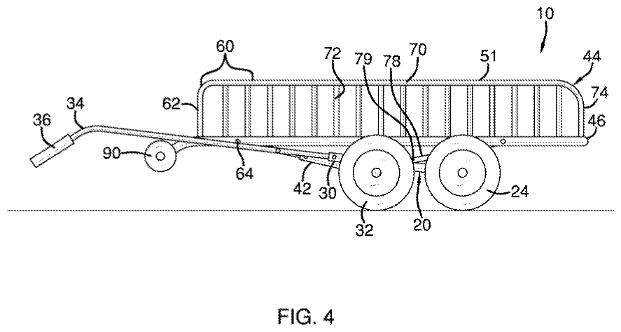

With reference now to the drawings, and in particular FIGS. 1 through 4 thereof, an example of the instant collapsible shopping cart employing the principles and concepts of the present collapsible shopping cart and generally designated by the reference number 10 will be described.

Referring to FIGS. 1 through 4 the present collapsible shopping cart 10 is illustrated. The collapsible shopping cart 10 includes a chassis 20. The chassis 20 includes a front axle 22 having a pair of front wheels 24 distally disposed thereon, a rear axle 26 parallel to the front axle 22, a telescopic right side front beam 28 extending rearwardly from the front axle 22, and a telescopic left side front beam 30 extending rearwardly from the front axle 22. The rear axle 26 has a pair of rear wheels 32 distally disposed thereon. Each of the right and left side front beams 28, 30 has an outer end 34. A handle 36 is disposed on the outer end 34 of each of the right and left side front beams 28, 30. A telescopic right side rear beam 40 extends forwardly from the rear axle 26 and a telescopic left side rear beam 42 extends forwardly from the rear axle 26.

A cargo basket 44 is mounted on the chassis 20 and is configured to store one or more items therein. The cargo basket 44 has a substantially rectangular floor panel 46 having a right side 48 and a left side 49. The floor panel 46 is surrounded by a pair of substantially rectangular longitudinal side wall panels 51, a transverse rear panel 53, and a transverse front wall panel 55. The rear panel 53 is hingedly attached to the floor panel 46 at a bottom edge 57 of the rear panel 53. The hinged attachment of the rear panel 53 to the floor panel 46 is configured to permit the rear panel 53 to swing downwardly into a position at least coplanar with the floor panel 46, and can also swing in a position out of the way below the floor panel 46. Each of the longitudinal side wall panels 51 has an extension portion 60 extending from the floor panel 46 rearwardly beyond the rear panel 53. The extension portion 60 has a rear end 62. Each of the right side rear beam 40 and the left side rear beam 42 extends from the rear axle 26 to a respective one of a pair of first pivot pins 64 on the respective right side 48 and left side 49 of the floor panel 46 in a position proximal to the front wall panel 55.

The floor panel 46 is formed of a plurality of rigid tubular members 66 arranged in a lattice configuration, which is configured to prevent most small objects, such as grocery items, from falling therethrough. Each of the longitudinal side wall panels 51 and the respective extension portion 60 has a continuous external frame 70 and a plurality of rails 72 longitudinally disposed from a forward end 74 of the respective one of the longitudinal side wall panels 51 to the rear end 62 of the respective extension portion 60. The rear panel 53 also has an exterior frame 75 with a plurality of vertical rail members 77 disposed within the exterior frame 75. The front wall panel 55 has a plurality of bars 76 horizontally disposed between and connecting the longitudinal side wall panels 51.

A pair of front support beams 78 is provided to ensure structural integrity of the cargo basket 44 in a balanced level position. Each of the pair of front support beams 78 has a lower end 79 pivotably disposed on the respective right side front beam 28 and the left side front beam 30 in a position proximal the front axle 22 and an upper end 80 pivotably disposed on the respective right side 48 and left side 49 of the floor panel 46 in a position proximal the front wall panel 55. A crossbeam 82 connects the right side rear beam 40 and the left side rear beam 42 together in a position proximal the respective one of the pair of first pivot pins 64. The crossbeam 82 assists the front support beams 78 in providing structural integrity of the cargo basket 44 as well as the entire structure of the shopping cart 10.

A pair of extension members 84 of the floor panel 46 is disposed on a lower side 85 of the extension portion 62 of each of the longitudinal side wall panels 51. Each of the pair of extension members 84 has an outward bend 87 extending rearwardly therefrom and a distal end 88. Each of the right side front beam 28 and the left side front beam 30 extends from the front axle 22 to a position at least the rear end 62 of the extension portion 60 of the respective one of the longitudinal side wall panels 51. A pair of maneuvering wheels 90 is provided to assist a shopper in maneuvering the chassis 20 and the cargo basket 44 within a vehicle by allowing the shopper to use the handles 36 to push the shopping cart 10 into the cargo area of the vehicle. One of the pair of maneuvering wheels 90 is disposed on the distal end 88 of each of the respective one of the pair of extension members 84.

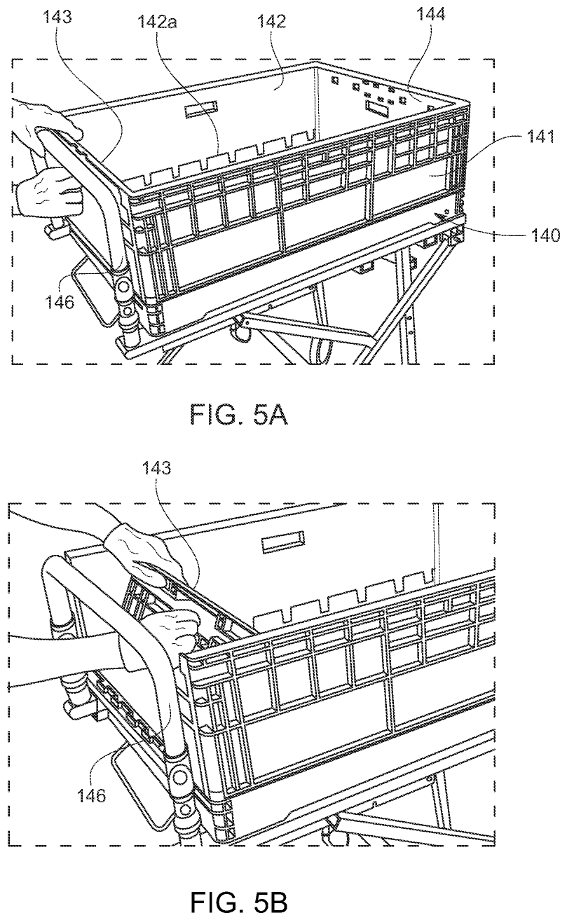

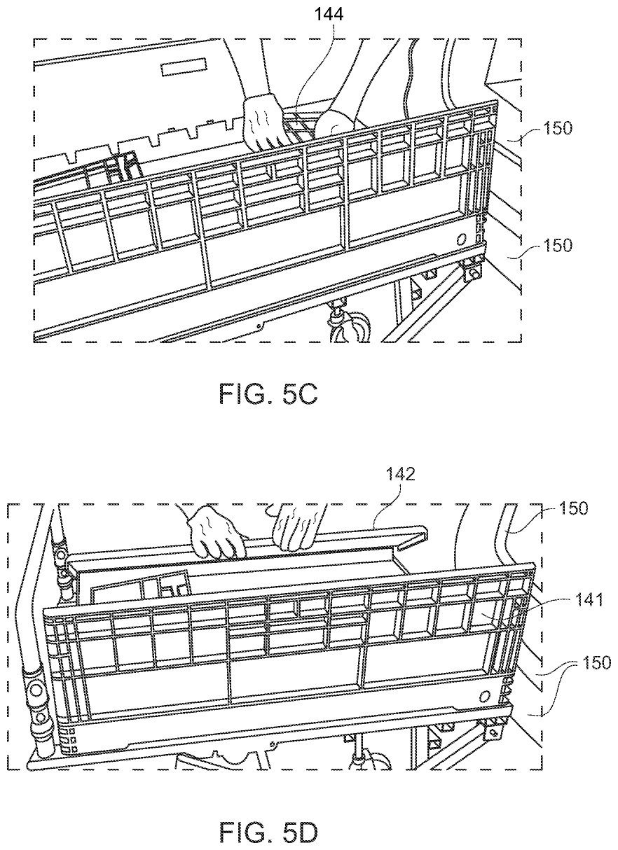

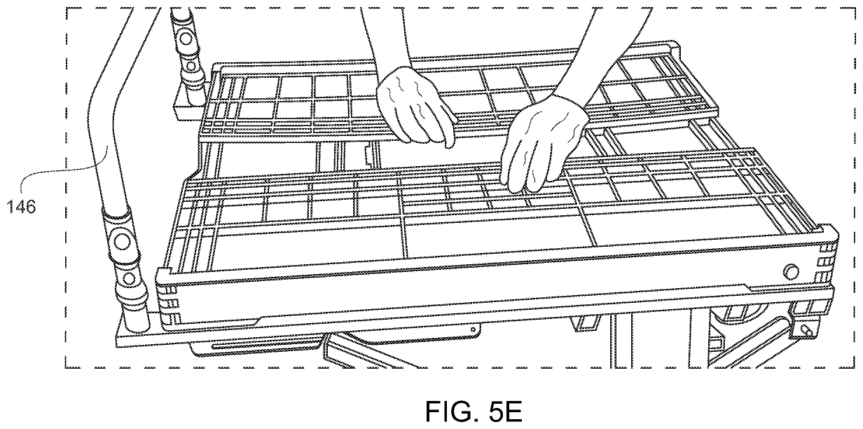

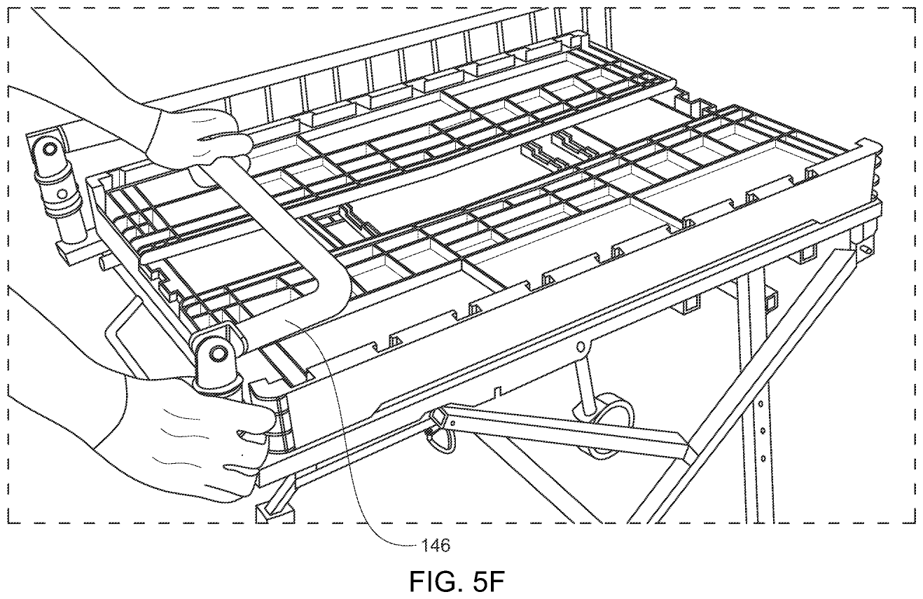

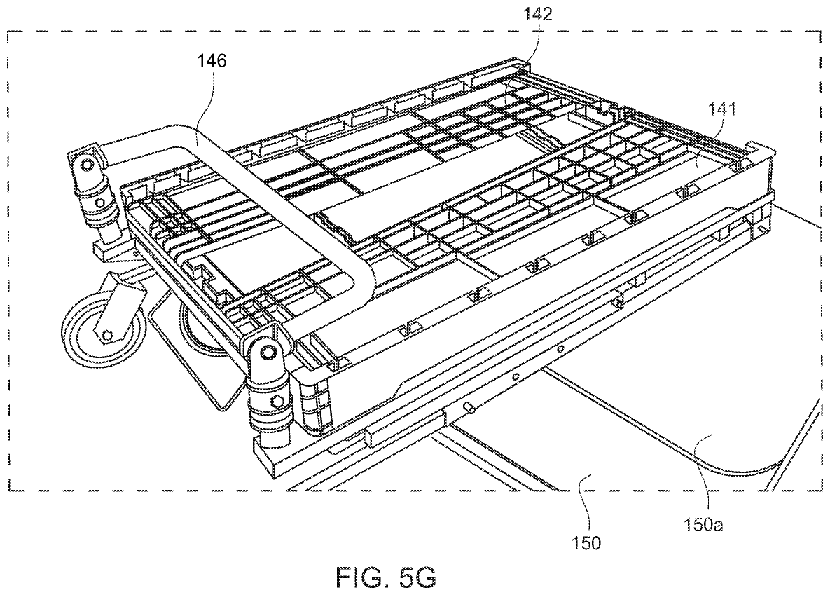

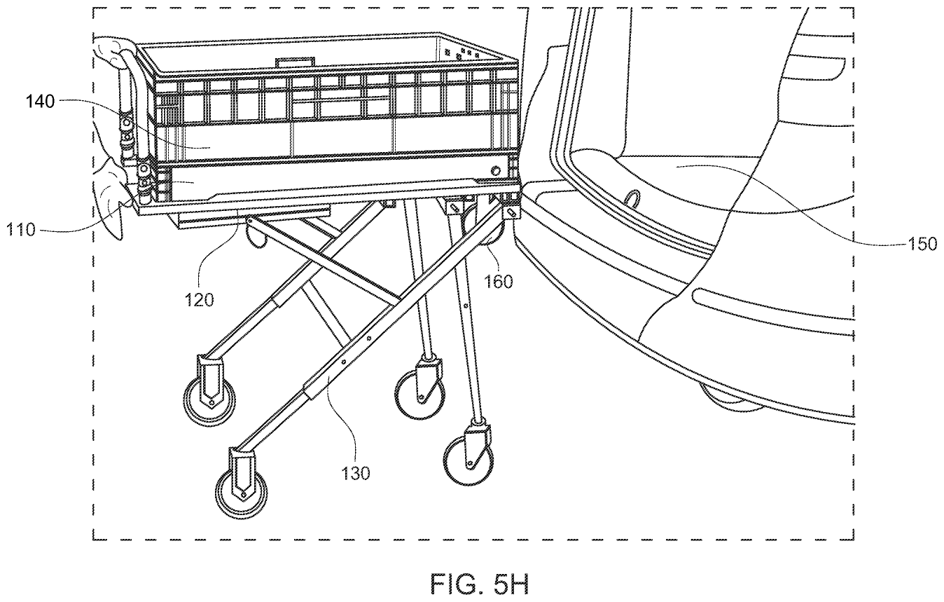

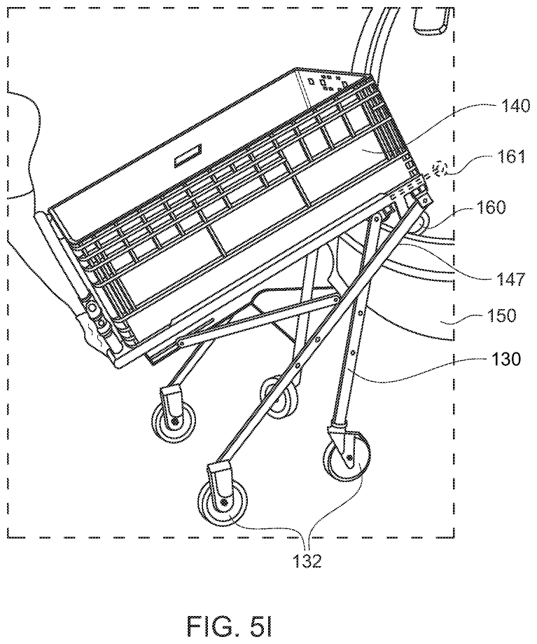

In the embodiment shown in FIGS. 5A through SI, with initial reference drawn to FIG. 5H, the cart 110 has a cargo basket 140 that rests atop a chassis 120, which chassis is supported above ground on a wheeling structure 130, as seen in FIGS. 5H and 5I As described above relative to the first embodiment, the wheeling structure 130 is collapsible as shown in the figures.

In departure from the first embodiment described above, the cargo basket 140 is itself collapsible into a small package by being comprised of four walls or panels 141, 142, 143, 144, including front, rear, right side and left side panels. Each of the panels is hingedly or pivotably mounted, as indicated by 142a for the panel 142, whereby as shown in the sequentially arranged figures, the front and rear panels 143, 144 are folded toward each other, followed by the right side and left side panels 141. 142 being folded toward each other and onto the front/rear panels. Lastly, the holding/pushing handle 146 is collapsed unto the four folded/stowed panels, presenting a very small foot print.

The chassis 120 also supports a front wheel or wheels 147 that allow the cart 110 to be pushed/rolled onto the floor 150a of the vehicle 150, which floor also applies the forces that collapse the wheeling structure 130, as shown in FIG. 5I The Cart 110 can be stored in the vehicle 150 with the cart basket 140 either collapsed or loaded with goods or materials. Since the cart 110 is being contacted with the vehicle during loading or unloading, various bumpers or other protectors may be add to protect again scratching the vehicle or the like.

To facilitate rolling of the either non-collapsed (or collapsed) cart 140 unto the vehicle floor 150a, forwardly disposed wheels 160 (one is shown) is located to first engage the vehicle floor 150a, as shown in FIG. 5H. And as the cart box/basket 140 is being pushed unto the vehicle 150, the various supporting struts 130/147 that are hingedly attached to the cart box 140 are forced to fold back and against the bottom of the cart box 140, generally as described above relative to the first embodiment of the present invention. The feature (shown in dashed lines) indicated by reference numeral 161 discloses a further embodiment in which the loading wheels 160 are hingedly (or slide-ably) attached to the cart box 140, so that the wheels 161 extend forwardly of the cart box 140, for rendering it easier to load/slide the cart box unto the floor 150a of the vehicle 150. The collapsible basket 140 described above can be mounted unto the chassis described in relation to the first embodiment described above.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A collapsible shopping cart, comprising:
a cargo basket supported on a chassis;
a collapsible wheeling structure including wheels that support the chassis above ground and allow rolling the cargo basket on the ground;
a handle coupled to the chassis for a user to grasp and control movement of the shopping cart; wherein
the cargo basket comprises at least four panels each of which is hingedly mounted to the chassis, in a manner so that the four panels are enabled to be folded down and over each other to selectively reduce a height dimension of the cargo basket for storage purposes. collapsed into horizontal planes and the handle is collapsible unto the collapsed panels.

2. The collapsible shopping cart of claim 1, wherein the handle is hingedly affixed to the shopping cart in a manner effective to enable the handle to be folded unto the four panels after said four panels have been folded unto each other.

3. The collapsible shopping cart of claim 2, including at least one front wheel that is attached to the chassis and is so configured as to enable rolling the shopping cart unto an elevated platform.

4. The collapsible shopping cart of claim 3, wherein the elevated platform is a floor of a vehicle.

5. The collapsible shopping cart of claim 3, wherein the at least one front wheel is movable relative to the chassis between an extended position located forward of the chassis and a stored, non-extended position.

6. The collapsible shopping cart of claim 3, wherein the at least one front wheel is so configured as to be forced to become folded back under the chassis as the shopping basket is pushed unto the elevated platform.

7. The collapsible shopping cart of claim 2, wherein the cargo basket is constructed of synthetic material.

8. A collapsible shopping cart comprising:
a chassis comprising: a front axle having a pair of front wheels distally disposed thereon; a rear axle disposed parallel to the front axle, the rear axle having a pair of rear wheels distally disposed thereon; a telescopic right side front beam extending rearwardly from the front axle; a telescopic left side front beam extending rearwardly from the front axle, wherein each of the right side front beam and the left side front beam has an outer end;
a handle disposed on the outer end of each of the right side front beam and the left side front beam;
a telescopic right side rear beam extending forwardly from the rear axle;
a telescopic left side rear beam extending forwardly from the rear axle;
a cargo basket mounted on the chassis and being configured to store one or more items therein, the cargo basket having a substantially rectangular floor panel having a right side and a left side, the floor panel surrounded by a pair of substantially rectangular longitudinal side wall panels, a transverse rear panel, and a transverse front wall panel, wherein the panels of the cargo basket are configured to be foldable unto the floor panel of the cargo basket;
a pair of front support beams, each of the pair of front support beams having a lower end pivotably disposed on the right side front beam and the left side front beam in a position proximal the front axle, and an upper end pivotably disposed on the right side and left side of the floor panel in a position proximal the front wall panel; a crossbeam connecting the right side rear beam and the left side rear beam together in a position proximal the respective one of the pair of first pivot pins; a pair of extension members of the floor panel disposed on a lower side of the extension portion of each of the longitudinal side wall panels, each of the pair of extension members having an outward bend extending rearwardly therefrom and a distal end, wherein each of the right side front beam and the left side front beam extends from the front axle to a position proximal the rear end of the extension portion of the respective one of the longitudinal side wall panels;
a pair of maneuvering wheels, one of the pair of maneuvering wheels disposed on the distal end of a respective one of the pair of extension members.

9. The collapsible shopping cart of claim 8, wherein the floor panel is formed of a plurality of rigid tubular members arranged in a lattice configuration.

10. The collapsible shopping cart of claim 9, wherein each of the longitudinal side wall panels and the respective extension portion has a continuous external frame and a plurality of rails longitudinally disposed from a forward end of the respective one of the longitudinal side wall panels to the rear end of the respective extension portion.

11. The collapsible shopping cart of claim 9, wherein the rear panel has an exterior frame with a plurality of vertical rail members disposed within the exterior frame and the front wall panel has a plurality of bars horizontally disposed between and connecting the longitudinal side wall panels.
